(19) United States
(12) Patent Application Publication
(10) Pub. No.: US 2013/0089219 A1
(43) Pub. Date: Apr. 11, 2013

(54) NOISE REDUCTION IN AN ELECTRONIC DEVICE

(71) Applicants: Luke Stephen ALLEN, Kincardine (CA); Robbie Donald EDGAR, Guelph (CA); Farhoud SHIRZADI, Kitchener (CA)

(72) Inventors: Luke Stephen ALLEN, Kincardine (CA); Robbie Donald EDGAR, Guelph (CA); Farhoud SHIRZADI, Kitchener (CA)

(73) Assignee: RESEARCH IN MOTION LIMITED, Waterloo (CA)

(21) Appl. No.: 13/253,282

(22) Filed: Oct. 5, 2011

(51) Int. Cl. H04R 1/40

(52) U.S. Cl. 381/97

(57) ABSTRACT

A method includes: detecting movement of a component of the electronic device; receiving an audio signal using a microphone of the electronic device, the audio signal including a noise signal corresponding to the component movement; and in response to detecting the component movement, combining the audio signal with a phase-inverted noise signal generated by phase inverting a recorded noise signal of the event received using the microphone of the electronic device.

### TECHNICAL FIELD

The present application relates to reduction in noise received by a microphone of an electronic device.

### BACKGROUND DISCUSSION

Electronic devices, including portable electronic devices, have gained widespread use and can provide a variety of functions including, for example, telephonic, electronic messaging and other personal information manager (PIM) application functions. With the rapid advancement of portable electronic device technology, devices have become smaller while device functionality has increased. In addition to including more functionality, electronic devices continue to achieve improved audio and video resolution. Since noise in the immediate environment reduces audio quality, noise reduction solutions are being improved.

### BRIEF DESCRIPTION OF THE DRAWINGS

Embodiments of the present application will now be described, by way of example only, with reference to the attached Figures, wherein:

FIG. 1 is a simplified block diagram of one example of a portable electronic device in accordance with the present disclosure;

FIG. 2 is a flowchart illustrating an example of a method of reducing event noise in accordance with the present disclosure;

FIG. 3 is a block diagram corresponding to an event noise reduction method;

FIG. 4 is a flowchart illustrating another example of a method of reducing event noise in accordance with the present disclosure;

FIG. 5 is a flowchart illustrating another example of a method of reducing event noise in accordance with the present disclosure; and

FIG. 6 is a flowchart illustrating an example of a method of training the portable electronic device in accordance with the present disclosure.

### DETAILED DESCRIPTION

In an aspect there is provided, a method including: detecting an event of a portable electronic device, the event corresponding to movement of a component of the portable electronic device; receiving an audio signal using a microphone of the portable electronic device, the audio signal comprising a noise signal corresponding to the event; and in response to detecting the event, combining the audio signal with a phase-inverted noise signal generated by phase inverting a recorded noise signal of the event, wherein the recorded noise signal was received using the microphone of the portable electronic device.

In another aspect there is provided, an electronic device including: a microphone for detecting an audio signal comprising a noise signal corresponding to an event, the event corresponding to a movement of a component of the electronic device; a memory for storing a digital representation of a recorded noise signal of the event, the recorded noise signal having been received using the microphone; and a processor for phase-inverting the recorded noise signal of the event and combining the audio signal with the phase-inverted signal in response to detection of the event.

It will be appreciated that for simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein. The example provided in the description is a portable electronic device, however, it will be appreciated that the method may be practiced on any electronic device.

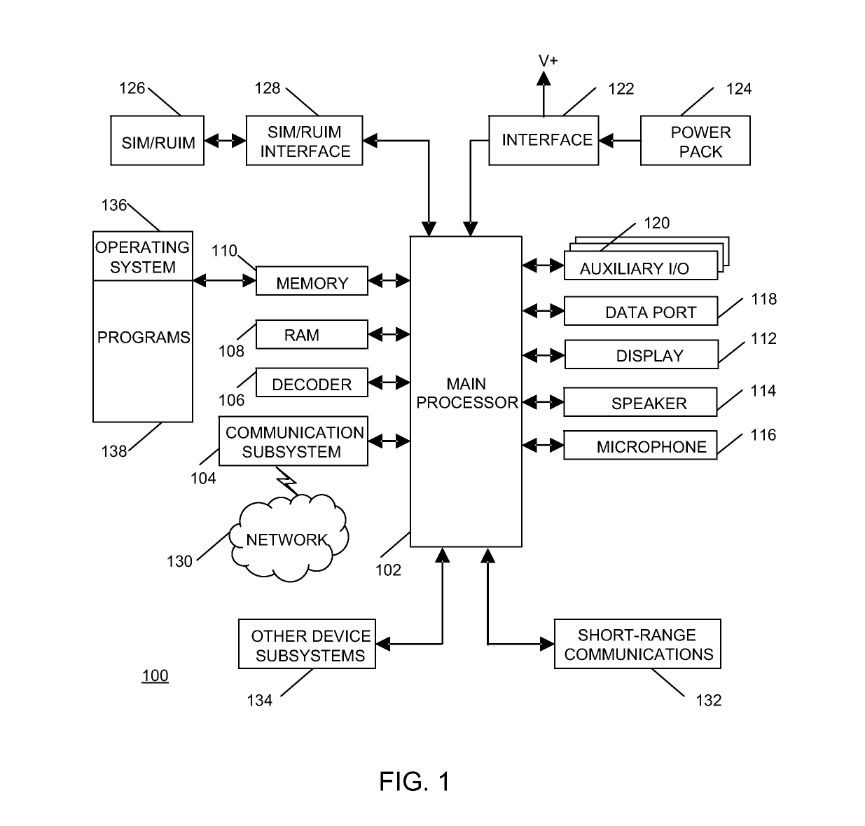

Referring now to FIG. 1, components of an example portable electronic device 100 are generally shown. The portable electronic device 100 includes data communication capabilities and may communicate with other electronic devices directly or through a wireless network. The portable electronic device 100 is based on the computing environment and functionality of a handheld computer. Generally, a handheld device is sized and shaped to be held or carried in a human hand. It will be understood, however, that the portable electronic device 100 is not limited to a handheld computer. Other portable electronic devices are possible, such as pagers, cellular telephones, smart telephones, wireless organizers, tablet computers, electronic messaging devices and wirelessly enabled notebook computers. The portable electronic device 100 includes an interface 122 for receiving a power pack 124, which powers the portable electronic device 100. The power pack 124 may be one or more rechargeable batteries or another type of fuel cell, for example.

The portable electronic device 100 includes a processor 102, which controls the overall operation of the device 100. A communication subsystem 104 controls data and voice communication functions, such as email, PIN (Personal Identification Number) message functions, SMS (Short Message Service) message functions and cellular telephone functions, for example. The communication subsystem 104 may receive messages from and send messages to a wireless network 130, which may be a data-centric wireless network, a voice-centric wireless network or a dual-mode wireless network. Data received by the portable electronic device 100 is decompressed and decrypted by a decoder 106.

In FIG. 1, the communication subsystem 104 is a dual-mode wireless network that supports both voice and data communications. The communication subsystem 104 is configured in accordance with the Global System for Mobile Communication (GSM) and General Packet Radio Services (GPRS) standards. The communication subsystem 104 may alternatively be configured in accordance with Enhanced Data GSM Environment (EDGE) or Universal Mobile Telecommunications Service (UMTS) standards. Other wireless networks may also be associated with the portable electronic device 100, including Code Division Multiple Access (CDMA) or CDMA2000 networks. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The wireless network 130 may include base stations (not shown) that provide a wireless link to the portable electronic device 100. Each base station defines a coverage area, or cell, within which communications between the base station and the portable electronic device 100 can be effected. The portable electronic device 100 is movable within the cell and may be moved to coverage areas defined by other cells.

The communication subsystem 104 further includes a short range communications function, which enables the device 100 to communicate directly with other devices and computer systems without the use of the wireless network 130 (which is not ordinarily thought of as a component of the device 100) through infrared or Bluetooth™ technology, for example.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110. The SIM/RUIM card 138 is used to identify the user of the portable electronic device, store personal device settings and enable access to network services, such as email and voice mail, for example, and is not bound to a particular portable electronic device 100.

The processor 102 is also connected to a Random Access Memory (RAM) 108 and a persistent updateable memory 110, such as a flash memory. The flash memory 110 may alternatively be a persistent storage, a Read-Only Memory (ROM) or other non-volatile storage.

The portable electronic device 100 includes an operating system 136 and software programs or components 138 that are executed by the processor 102 and are typically stored in a persistent, updatable store such as the memory 110. Additional applications or programs may be loaded onto the portable electronic device 100 through the wireless network 130, the auxiliary I/O subsystem 120, the data port 118, the short-range communications subsystem 132, or any other device subsystem 134. Some examples of software applications that may be stored on and executed by the device 100 include: electronic messaging, games, calendar, address book and music player applications. Software applications that control basic device operation, such as voice and data communication, are typically installed during manufacture of the device 100.

A received signal such as a text message, an e-mail message, or web page download is processed by the communication subsystem 104 and input to the processor 102. The processor 102 processes the received signal for output to the display 112 and/or to the auxiliary I/O subsystem 120. A subscriber may generate data items, for example e-mail messages, which may be transmitted over the wireless network 130 through the communication subsystem 104. For voice communications, the overall operation of the portable electronic device 100 is similar. The speaker 114 outputs audible information converted from electrical signals, and the microphone 116 converts audible information into electrical signals for processing.

The portable electronic device 100 components are provided in a housing (not shown), which typically gives some structural integrity or overall shape to the device 100 and which may be part of the device frequently touched by a user. The housing that may expose the display 112, the speaker 114 and device buttons (not shown), for example. The portable electronic device 100 may include camera hardware and associated software that is executable by the processor 102. Some device components are movable relative to the housing and some components are generally fixed relative to the housing. Movable components of the portable electronic device 100 (components that move with respect to the housing or with respect to most other components of the device 100) may generate noise during or by movement. The different movements of the movable components may be referred to as events. Examples of events include: extension or retraction of a telescoping camera lens, actuation of a device button, insertion and removal of a stylus, motor vibration and form factor adjustments, such as movement of a slidable element between a stowed position and a deployed position, movement of a flip phone between open and closed positions, swiveling of a portion of a device and pop-out mechanisms, for example. Not all events or component movements generate unwanted noise, but for simplicity of discussion, it may be generally assumed that an event causes sound and that sound may be noise.

Noise generated by an event may provide useful feedback to indicate that a device component is performing a selected operation, however, when the microphone 116 is operating, the noise generated by an event may result in audio degradation in a telephone conversation or video recording, for example.

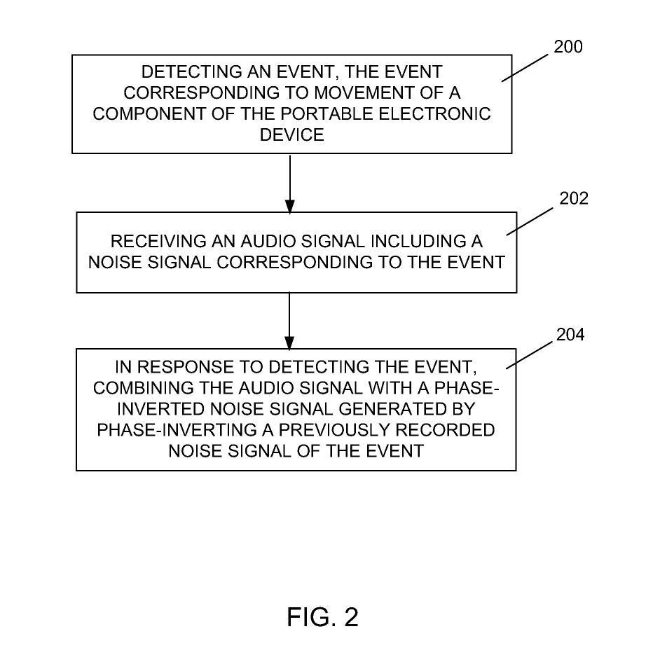

FIG. 2 is a flowchart illustrating an example of a method of reducing event noise The method may be carried out by software executed by, for example, the processor 102. Coding of software for carrying out such a method is within the scope of a person of ordinary skill in the art given the present description. The method may contain additional or fewer processes than shown and described, and may be performed in a different order. Computer-readable code executable by, for example, the processor 102 of the portable electronic device 100 to perform the method, may be stored in a computer-readable medium.

Referring to FIG. 2, the method includes: detecting 200 an event of a portable electronic device 100, the event corresponding to a movement of a component of the portable electronic device 100; receiving 202 an audio signal using a microphone 116 of the portable electronic device 100, the audio signal including a noise signal corresponding to the event; and in response to detecting the event, combining 204 the audio signal with a phase-inverted noise signal generated by phase inverting a recorded noise signal (typically a noise signal recorded at some time prior to the detection 200) of the event. The recorded noise signal having been received using the microphone of the portable electronic device. In general, an event corresponds to a movement of a component when the component moves, for example, with respect to the housing, and an audio signal or a noise signal corresponds to an event when the signal is causally related to the event.

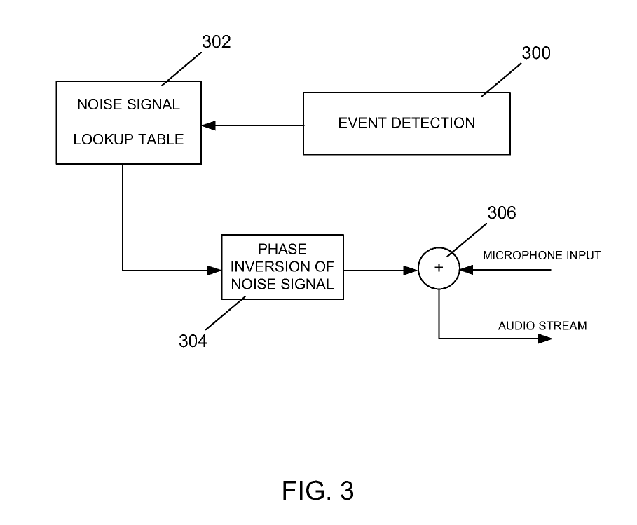

Referring to FIG. 3, a system corresponding to the method of reducing noise of FIG. 2 includes: an event detection block 300, which performs event detection by communicating with components and/or software applications that are associated with the event. In the telescoping camera lens example, the processor 102 sends control signals to move the camera lens when a signal is received to move the telescoping camera lens. The control signals may be branched, multiplexed or processed in parallel to be transmitted to select the phase-inverted noise signal from the noise signal look-up table 302. For a button click, form factor adjustment or any event for which the processor 102 receives a corresponding control signal relating to movement at the portable electronic device 100, the actuation signal is again branched, multiplexed or processed in parallel to be transmitted to select the phase-inverted noise signal from a noise signal look-up table 302.

The noise signal look-up table block 302 locates previously stored or recorded digital representations, such as audio files, of the noises that correspond to the detected events. A look-up table may include any number of events stored in association with the corresponding noises and may be stored in memory 110. The look-up table is populated by recording event noise signals at the portable electronic device 100 and storing digital representations of the noise signals in the memory 110 in association with the event. Population of the look-up table may be performed following assembly of the portable electronic device 100 by the device manufacturer. Alternatively, the look-up table may be populated via a download or firmware.

The phase inversion of noise signal block 304 performs phase-inversion of the recorded noise signal when the recorded noise signal associated with the event has been determined. The inversion may be performed using hardware or, alternatively, the sign of the digital signal may be changed in a digital signal processing step of a software application. In one embodiment, the noise signals pass through the phase-inverter prior to being stored in association with the lookup table.

An adder 306 receives the phase-inverted noise signal and receives an audio signal, which includes the noise signal corresponding to the event. The phase-inverted noise signal is input to the adder 306 at generally the same time as the noise signal corresponding to the event is generated either in real time or by using appropriate buffering to generally align the signals in order to generally cancel the noise from the combined audio signal. The combining may be done in any fashion: it may be performed digitally or by analog techniques, or via superposition, or with a summing circuit, for example. The resulting audio stream exits the adder 306 and output by the microphone 116.

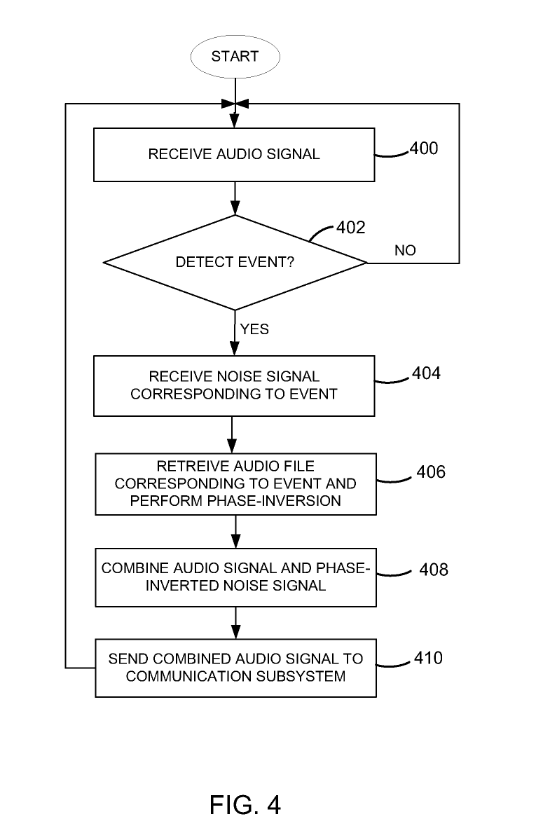

Referring to FIG. 4, another example method of reducing event noise includes: receiving 400 an audio signal at the microphone 116, when an event is detected 402, receiving 404 a noise signal corresponding to the event at the microphone 116, the noise signal being part of the audio signal, retrieving 406 an audio file corresponding to the event and performing phase-inversion in order to provide a phase-inverted noise signal, combining 408 the audio signal and the phase-inverted noise signal and sending 410 the combined audio signal to the communication subsystem 104 for transmission over a communication link. The combined audio signal may be transmitted as part of a telephone call or as part of an audio and/or video upload to the internet, for example.

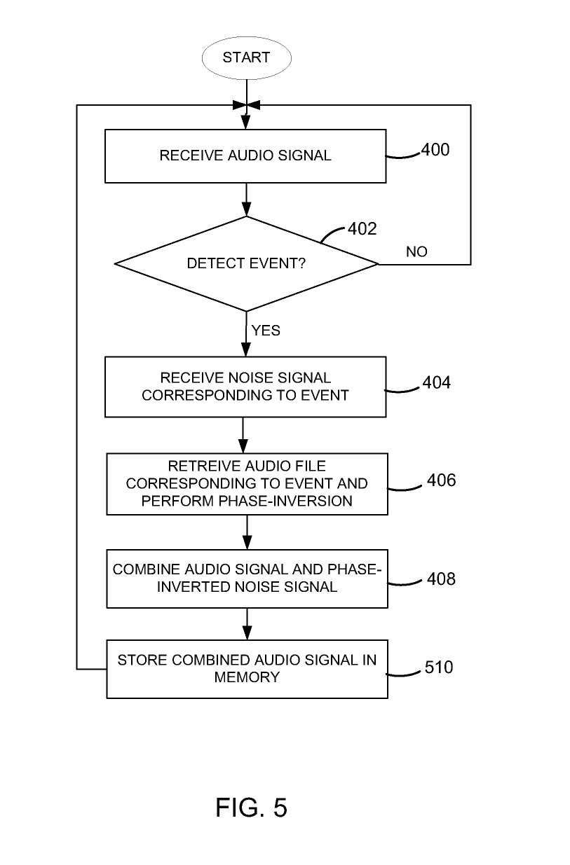

Referring to FIG. 5, another example method of reducing event noise is provided. The example method of FIG. 5 is similar to the example method of FIG. 4, however, includes storing 510 a digital representation of the combined audio signal in memory 110. In this example method, the digital representation may be an audio file or as an audio/video file for example.

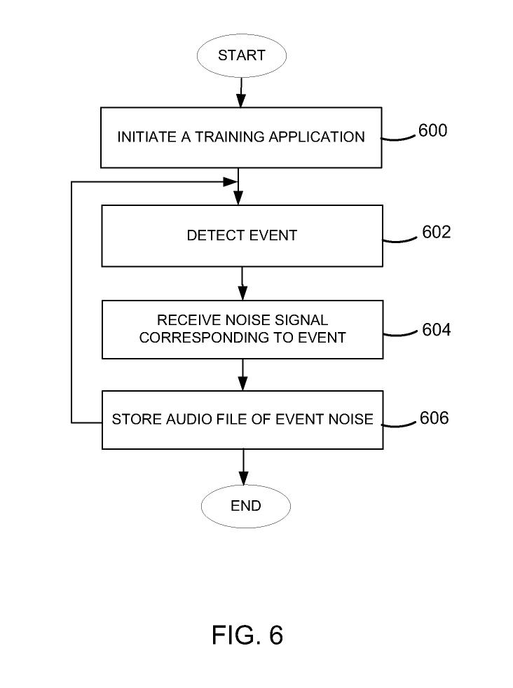

A method of training the portable electronic device 100 to reduce event noise is shown in FIG. 6. The method populates the look-up table and may be performed following assembly of the portable electronic device 100 by the device manufacture or by the user. In addition, the method may be performed at any time over the lifetime of the portable electronic device 100 in order to update the look-up table. By recording the noise signals using the microphone 116 of the portable electronic device 100 rather than using manufacturer-standard noise signals, high quality noise reduction may be achieved. Further, noise reduction may be adjusted over time in order to compensate for changes in the noises made by moving components as they wear, for example.

The method of FIG. 6 includes: initiating 600 a training application to enable writing to a look-up table, detecting 602 an event, receiving 604 a noise signal corresponding to the event at the microphone 116 and storing 606 the noise in the look-up table in association with the event. The method may be performed for more than one event. When the method is complete, writing to the look-up table is disabled. The event is captured using normal control feedback. For example, a signal path for a button press is additionally routed to write to the event column in the look-up table. The training method is typically performed in a quiet environment in order to generally isolate the event noise.

In one embodiment, the training application provides user prompts on the display 112 to guide the user through the training method. The software application may request additional events, such as different lens positions for a telescoping lens, for example.

For portable electronic devices 100 that are capable of being customized, the method of FIG. 6 may be performed in order to reduce event noise associated with added components. An example of an added component is a digital SLR camera lens that may be added to a portable electronic device including a camera.

The methods and apparatus described herein improve the quality of audio being transmitted or recorded by a portable electronic device by reducing the noise associated with movement of a movable component. For example, when recording a video, the noise associated with the telescoping lens extending and retracting to zoom in and out may be reduced. Similarly, when actuating a volume adjustment button during a telephone call the button actuation noise may be reduced. Further, the noise associated with deploying and stowing the keyboard of a slider phone during a telephone call or a video recording may be reduced. In addition, the concepts support the benefits of adaptability and customization, as they can be applied to a variety of devices having a variety of components, and that may generate noise in different ways. Further, the techniques can be readily implemented in a handheld device, where considerations of size and weight may be especially important.

The above-described embodiments are intended to be examples only. Alterations, modifications and variations can be effected to the particular embodiments by those of skill in the art without departing from the scope of the present application, which is defined solely by the claims appended hereto.

What is claimed is:

1. A method comprising:
detecting an event of an electronic device, the event corresponding to movement of a component of the electronic device;
receiving an audio signal using a microphone of the electronic device, the audio signal comprising a noise signal corresponding to the event; and
in response to detecting the event, combining the audio signal with a phase-inverted noise signal generated by phase inverting a recorded noise signal of the event,
wherein the recorded noise signal was received using the microphone of the electronic device.

2. A method as claimed in claim 1, comprising storing the combined audio signal and phase-inverted noise signal in a memory of the electronic device.

3. A method as claimed in claim 1, comprising sending the combined audio signal and phase-inverted noise signal over a communication link.

4. A method as claimed in claim 1, wherein the event is detected by receiving control signals associated with the event at a processor of the electronic device.

5. A method as claimed in claim 1, wherein the recorded noise signal is re-recordable to compensate for changes in event noise over time.

6. A method as claimed in claim 1, wherein a digital representation of the recorded noise signal is stored in a memory of the electronic device.

7. A method as claimed in claim 6, wherein the the digital representation of the recorded noise signal is stored in a look-up table in association with the event.

8. A method as claimed in claim 1, wherein the event is one of: a button actuation, camera lens movement or a form factor adjustment of the electronic device.

9. A method as claimed in claim 1, wherein the recorded noise signal is generated by:
detecting a previous event of the electronic device and storing a digital representation of the corresponding noise signal in a memory of the electronic device in association with the previous event.

10. An electronic device comprising:
a microphone for detecting an audio signal comprising a noise signal corresponding to an event, the event corresponding to a movement of a component of the electronic device;
a memory for storing a digital representation of a recorded noise signal of the event, the recorded noise signal having been received using the microphone; and
a processor for phase-inverting the recorded noise signal of the event and combining the audio signal with the phase-inverted signal in response to detection of the event.

11. An electronic device as claimed in claim 10, wherein the event is one of: a button actuation, camera lens movement or form factor adjustment of the electronic device.

12. An electronic device as claimed in claim 10, wherein the event is detected by receiving control signals associated with the event at the processor.

13. An electronic device as claimed in claim 10, wherein the recorded noise signal is re-recordable to compensate for changes in event noise over time.

14. An electronic device as claimed in claim 10, wherein the recorded noise signal is generated by: detecting a previous event of the electronic device and storing a digital representation of the corresponding noise signal in a memory of the portable electronic device in association with the previous event.

15. An electronic device as claimed in claim 10, wherein a digital representation of the combined audio signal and phase-inverted signal is stored in a memory of the electronic device.

16. An electronic device as claimed in claim 11, wherein the combined audio signal and phase-inverted signal is transmitted over a communication link.

17. An electronic device as claimed in claim 10, wherein the digital representation of the recorded noise signal is stored in a look-up table in association with the event.
